(19) United States
(12) Patent Application Publication
(10) Pub. No.: US 2025/0190204 A1
(43) Pub. Date: Jun. 12, 2025

(54) DATA STORAGE DEVICE, SYSTEM INCLUDING THE SAME, AND METHOD OF DOWNLOADING FIRMWARE

(71) Applicant: SAMSUNG ELECTRONICS CO., LTD., SUWON-SI (KR)

(72) Inventors: Dongjun Lee, Suwon-si (KR); Sanghun Kim, Suwon-si (KR); Junki Sung, Suwon-si (KR); Jeongmin Kim, Suwon-si (KR); Minki Son, Suwon-si (KR); Geunho Choi, Suwon-si (KR)

(21) Appl. No.: 18/829,994

(22) Filed: Sep. 10, 2024

(30) Foreign Application Priority Data
Dec. 6, 2023 (KR) 10-2023-0175932

(51) Int. Cl. G06F 8/65

(52) U.S. Cl. CPC G06F 8/65

(57) ABSTRACT

A method of downloading firmware includes executing a debug mode by reading a complete signature, checking whether download steps of firmware have been completed, and executing the firmware based on the complete signature. The debug mode includes writing a start signature in response to a start operation of the download steps, writing a write signature in response to completion of the write operation of the firmware of the download steps, and writing the complete signature in response to all of the download steps being completed.

### CROSS-REFERENCE TO RELATED APPLICATION

This application claims priority under 35 U.S.C. § 119 from Korean Patent Application No. 10-2023-0175932, filed on Dec. 6, 2023 in the Korean Intellectual Property Office, the contents of which are herein incorporated by reference in their entirety.

### TECHNICAL FIELD

Embodiments of the inventive concept are directed to a data storage device, and more particularly, to a data storage device for downloading firmware, a system that includes the data storage device, and a method of downloading firmware.

### DISCUSSION OF THE RELATED ART

Various data storage devices and embedded systems that include the data storage devices may include firmware, which is a system operating program, in a storage device. A device can perform various functions by externally downloading or updating this firmware.

However, because firmware is a program that directly affects devices and systems, the process of handling firmware involves considerable attention. If the download cannot be completed due to an error, serious problems can occur, such as distortion of data stored in a device or an operation failure of the device. Accordingly, a need for technology that improves the stability of the process of downloading and/or updating firmware is increasing.

### SUMMARY

Embodiments of the inventive concept provide a data storage device with improved firmware control performance, a system that includes the data storage device, and a method of downloading firmware.

According to an embodiment of the inventive concept, there is provided an operating method of a storage device. The operating method includes receiving firmware from an external host device, executing a debug mode, checking whether download steps of the firmware have been completed by reading a complete signature, and executing the firmware based on the complete signature. Executing the debug mode includes writing a start signature in response to a start operation of the download steps, writing a write signature in response to completion of the write operation of the firmware of the download steps, and writing the complete signature in response to all of the download steps having completed.

According to another embodiment of the inventive concept, there is provided a data storage device that includes at least one processor that controls download of firmware by executing a debug mode in response to an application of power, a nonvolatile memory that includes a bootloader memory area that store a program that boots the data storage device, a firmware memory area that stores the firmware, and a signature memory area that stores a signature that corresponds to each of download steps of the firmware, and a random access memory (RAM) that copies, by the at least one processor, the firmware stored in the firmware memory area based on a complete signature. In the debug mode, the at least one processor writes a start signature in the signature memory area in response to a start operation of the download steps, writes a write signature in response to completing the write operation of the firmware of the download steps, and writes the complete signature in response to completion of all of the download steps.

According to another embodiment of the inventive concept, there is provided a system that includes a host device that provides firmware, and a data storage device that includes at least one processor and that downloads the firmware from the host device and stores the firmware in firmware memory area. The at least one processor enters a debug mode to perform download steps of the firmware, boots the data storage device based on a program stored in a bootloader memory area, and copies the firmware stored in the firmware memory area to a RAM and executes the firmware based on a complete signature of a signature memory area. In the debug mode, the at least one processor writes a start signature in the signature memory area in response to a start operation of the download steps, writes a write signature in response to completing the write operation of the firmware of the download steps, and writes the complete signature in response to completion of all of the download steps.

### BRIEF DESCRIPTION OF THE DRAWINGS

FIG. 1 is a block diagram of a data processing system according to an embodiment.

FIG. 2 is a block diagram of a data storage device according to an embodiment.

FIG. 3 is a block diagram of a memory area of a device, according to an embodiment.

FIG. 4 is a flowchart of a firmware download method according to an embodiment.

FIG. 5 is a flowchart of a debug mode according to an embodiment.

FIG. 6 is a flowchart of a debug method according to an embodiment.

FIG. 7 is a block diagram of a firmware download system according to an embodiment.

FIG. 8 is a block diagram of a data storage device incorporated into a solid state drive (SSD) system, according to an embodiment.

### DETAILED DESCRIPTION

Hereinafter, embodiments of the inventive concept will be described in detail with reference to the attached drawings.

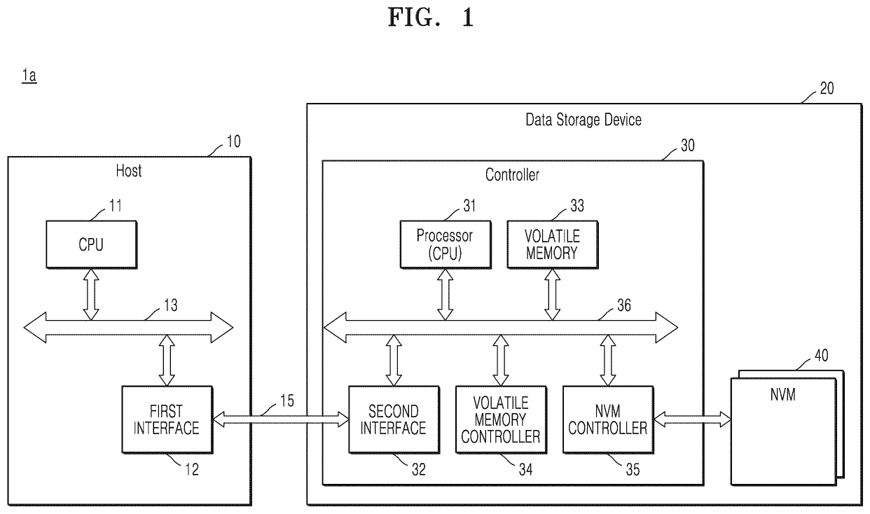

FIG. 1 is a block diagram of a data processing system according to an embodiment.

Referring to FIG. 1, in an embodiment, a data processing system 1a may include a host 10, such as a device that provides firmware, and a data storage device 20 that are connected to each other through an interface 15.

The data processing system 1a may be any one of a server computer, a personal computer (PC), a desktop computer, a lap-top computer, a workstation computer, a network-attached storage (NAS), a data center, an internet data center (IDC), or a mobile computing device. For example, the mobile computing device may be implemented using one of a smartphone, a tablet PC, or a mobile internet device (MID).

The host 10 may control data processing operations, such as write operations or read operations, of the data storage device 20. In addition, the host 10 may transmit a request to provide firmware to the data storage device 20, or a request to update the current installed firmware, and the firmware itself to the data storage device 20 through the interface 15. In some embodiments, the interface 15 may correspond to a wireless communication network, and the data storage device 20 may download new firmware through the wireless communication network.

Firmware may include linked binaries. When downloading (or updating) is unexpectedly interrupted while the data storage device 20 is receiving firmware through the interface 15, links may be broken and the firmware might not execute normally. However, the data storage device 20 according to an embodiment can smoothly restore (or re-download), through a debug mode, the firmware whose download was interrupted.

The host 10 may include a central processing unit (CPU) 11 and a first interface 12. The block diagram of the host 10 illustrated in FIG. 1 is shown as an example for convenience of description, and embodiments of the inventive concept are not necessarily limited to the block diagram illustrated in FIG. 1. Accordingly, the host 10 may further include other components in addition to the CPU 11 and the first interface 12. According to various embodiments, the host 10 may be implemented as one of an integrated circuit (IC), a motherboard, or a system on chip (SoC), but is not necessarily limited thereto. According to an embodiment, the host 10 may be implemented as one of an application processor or a mobile application processor.

The CPU 11 can transmit or receive commands and/or data to or from the first interface 12 through a bus architecture 13. For example, the bus architecture 13 may be, but not limited to, one of an Advanced Microcontroller Bus Architecture (AMBA), an AMBA Advanced extensible Interface (AXI), an Advanced Peripheral Bus (APB), or an AMBA Advanced High-performance Bus (AHB). The CPU 11 may transmit a request to update, or a request to download, the current firmware installed in the data storage device 20 and the updated firmware (or new firmware) to the data storage device 20 through the first interface 12 and the interface 15. The CPU 11 may refer to a processor that can execute program(s) that can perform operations according to an embodiment. The first interface 12 may be connected to a second interface 32 of the data storage device 20 through the interface 15. For example, each interface, such as the first interface 12, the interface 15, and the second interface 32, may be implemented using an interface that supports at least one of the peripheral component interconnect express (PCIe) protocol, the serial advanced technology attachment (SATA) protocol, the SATA Express (SATAe) protocol, the Serial Attached Small Computer System Interface (SCSI) (SAS) protocol, or the non-volatile memory express (NVMe) protocol, but is not necessarily limited thereto.

The data storage device 20 may include a controller 30 and a nonvolatile memory (NVM) 40.

A method of downloading (or updating) firmware that is performed by the data storage device 20 according to an embodiment, may include checking, by the data storage device 20, the download status of the firmware through a signature, and determining whether to execute the firmware based on a signature. In addition, when an error occurs in firmware download, the data storage device 20 according to an embodiment may perform a download restoration operation without a separate manual operation through a debug mode of a processor 31.

The data storage device 20 may be implemented by a flash-based memory device, but is not necessarily limited thereto. For example, the data storage device 20 may be implemented using a solid-state drive or solid-state disk (SSD), an embedded SSD (eSSD), a universal flash storage (UFS), a multimedia card (MMC), embedded MMC (eMMC), secure digital (SD) card in the form of SD, mini-SD or micro-SD, a Universal Storage Bus (USB) storage device, a Universal Flash Storage (UFS) device, a compact flash (CF) card, a smart media card, a memory stick, etc. In an embodiment, when the data storage device 20 is an SSD, the data storage device 20 may be one of a portable SSD, a client SSD (cSSD), a data center SSD (DC SSD), or an enterprise SSD (EP SSD). In an embodiment, the data storage device 20 may be implemented using a hard disk drive (HDD). The data storage device 20 can be connected to or disconnected from the host 10. According to an embodiment, the data storage device 20 may be implemented in the form of a memory module.

The controller 30 may control transmission of commands and/or data transmitted or received between the host 10 and the nonvolatile memory 40. The controller 30 may include the processor 31, such as a CPU, the second interface 32, a volatile memory 33, a volatile memory controller 34, and a non-volatile memory (NVM) controller 35.

The second interface 32 may be connected to the first interface 12 of the host 10 through the interface 15.

The processor 31 may control the operations of the second interface 32, the volatile memory 33, the volatile memory controller 34, and the NVM controller 35 through a bus structure 36. The processor 31 can perform operations according to an embodiment. The operations may include controlling a firmware download (update) process of the data storage device 20, and, for example, determining whether the download is complete, based on a debug mode according to an embodiment. In some embodiments, a circuit that performs the above operations may be implemented within the processor 31.

The second interface 32, the processor 31, the volatile memory 33, the volatile memory controller 34, and the NVM controller 35 may transmit or receive commands and/or data through a bus structure 36. The bus structure 36 may be one of the AMBA, AXI, APB, or AHB as described above, but is not necessarily limited thereto.

The volatile memory 33 may store, for example, mapping data that maps a logical address to a physical address and/or data about errors that occur in an NVM access operation, such as a write operation (or program operation) or a read operation, or locations of memory cells in which the errors occur. In an embodiment, the volatile memory 33 may be a volatile memory such as one of a dynamic random access memory (DRAM), a static random access memory (SRAM), a cache, or a tightly coupled memory (TCM), but is not necessarily limited thereto. In addition, in FIG. 1, the volatile memory 33 is implemented outside the processor 31, but embodiments of the inventive concept are not necessarily limited thereto. In some embodiments, the volatile memory 33 may be implemented inside the processor 31. The volatile memory controller 34 may control access operations, such as write operations (or program operations) to the volatile memory 33 under control of the processor 34.

The NVM controller 35 may write data, such as data related to firmware download, to the NVM 40 or reads data stored in the NVM 40, such as data related to firmware download, based on the processor 31 and a debug mode executed by the processor 31.

The NVM 40 may be implemented as a flash-based memory, but is not necessarily limited thereto. For example, the flash-based memory may be implemented using a NAND type flash memory or a NOR type flash memory. The flash-based memory may include a plurality of memory cells and an access control circuit that controls an access operation, such as a program operation or a read operation, on the plurality of memory cells. Each of the plurality of memory cells may store 1 or more bits of information. According to various embodiments, the NVM 40 may be implemented as one of an electrically erasable programmable read-only memory (EPROM), a magnetic RAM (MRAM), a spin-transfer torque MRAM, a ferroelectric RAM (FRAM), a phase change RAM (PRAM), a resistive RAM (RRAM), a nanotube RRAM, a polymer RAM (PoRAM), a nano floating gate memory (NFGM), a holographic memory, a molecular electronics memory device or an insulator resistance change memory.

In some embodiments, the NVM 40 may store downloaded (updated) firmware and also a signature that indicates whether the download proceeded normally. When a firmware update is performed, the current firmware may be replaced with the updated firmware.

In some embodiments, by executing a debug mode before booting the system, the data storage device 20 may prevent phenomena such as an interruption of the operation of a device or data distortion due to download errors or update errors. In addition, even if downloads and updates are not completed properly, a debug mode is executed without separate manual work, and thus, the resources consumed in a process may be reduced and damage to a device due to manual work may be reduced.

In addition, the data storage device 20 may stably controls the debug mode by embedding a debug circuit in hardware that executes the debug mode. A method of downloading firmware of the data storage device 20 according to an embodiment is described in detail with reference to the drawings below.

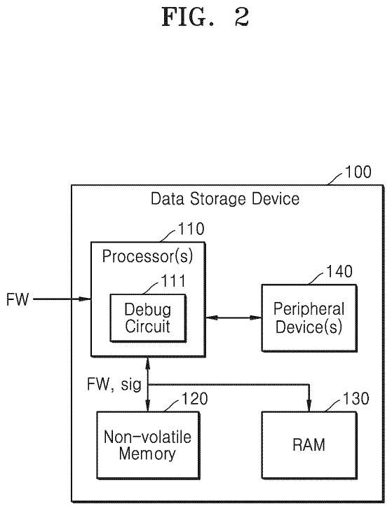

FIG. 2 is a block diagram of a data storage device according to an embodiment.

Referring to FIG. 2, in an embodiment, a data storage device 100 may include a processor 110, a non-volatile memory 120, a random access memory (RAM) 130, and peripheral devices 140. The processor 110 may correspond to the processor 31 of FIG. 1, the non-volatile memory 120 may correspond to the non-volatile memory 40 of FIG. 1, and the RAM 130 corresponds to the volatile memory 33 of FIG. 1. Regarding each component, repeated descriptions with reference to the previous drawings may be summarized or omitted.

The processor 110 may receive firmware FW to be downloaded (or updated; hereinafter referred to as ‘download’ for convenience of description) from an external source. The firmware FW can be received through several interfaces, as described above in FIG. 1. In some embodiments, when power is applied to download the firmware FW, the processor 110 may first execute or enter a debug mode before booting the system. In some embodiments, the debug mode is implemented in hardware. For example, a debug circuit 111 that executes the debug mode may include a circuit implemented within the processor 110. For example, the debug circuit 111 may be implemented in advance through a masking operation during a process of manufacturing the processor 110, and thus cannot be arbitrarily changed, and may operate without a separate program when power is applied. When power is applied to the data storage device 100 to receive the firmware FW, the processor 110 may execute the debug mode based on the debug circuit 111. In some embodiments, when the processor 110 determines that downloading the firmware FW has not been completed, the processor 110 may again executes the debug mode.

The debug mode may include a plurality of download steps, as will be described in detail below. The processor 110 can transmit and receive data to or from the non-volatile memory 120 to perform a plurality of download steps in the debug mode. In some embodiments, the processor 110 may transmit a signature sig that indicates whether a plurality of download steps in the debug mode have been completed, and writes (stores) the signature sig in the non-volatile memory 120. The processor 110 may read the signature sig from the non-volatile memory 120. The processor 110 may also stores the received firmware FW in the non-volatile memory 120.

The non-volatile memory 120 may store the firmware FW received from the processor 110, and may store the signature sig that indicates whether a plurality of download steps of a process of downloading the firmware FW in a debug mode have been completed.

The RAM 130 operate a program by copying firmware from the non-volatile memory 120 under control by the processor 110. For example, the processor 110 may store the received firmware FW in the non-volatile memory 120, and when the download steps of the firmware FW have normally completed, the firmware FW stored in the non-volatile memory 120 may be executed by copying the firmware FW to the RAM 130.

The peripheral devices 140 may include any device that provides a useful function. For example, the peripheral devices 140 may include one or more of a user input device, a sensor, a communication device, a module, an output device, a display, a speaker, a power supply device, etc., and may also include switches that are connected to additional peripheral devices. In some embodiments, the peripheral devices 140 may include only some of the above devices or may further include other types of peripheral devices.

For example, the data storage device 100 according to an embodiment may first execute the debug mode before booting the system when power is applied to the data storage device 100. In addition, if it is determined that the download of the firmware FW has not been properly completed, the debug mode is repeated without booting the system, thereby preventing an interruption of an operation of a device due to an error in the download of the firmware FW and a resulting failure to execute of the firmware FW, and also preventing serious errors in the device, such as distortion of data. Furthermore, even if existing firmware is not installed in the data storage device 100, the data storage device 100 according to an embodiment executes a debug mode before executing the firmware, and thus, the data storage device 100 can restore the firmware FW by itself.

In addition, even if the download of the firmware FW has not normally completed, the data storage device 100 according to an embodiment executes the debug mode without any additional work, and thus, unnecessary manual work, such as physical work that uses an external device, is not required, and thus, resources consumed in the process and damage that occurs to the device due to the manual work can be reduced.

In addition, in the data storage device 100 according to an embodiment, the debug circuit 111 that executes the debug mode may be implemented as hardware within the processor 110 of a controller, and thus arbitrary changes by external control are impossible and no separate software is required, and accordingly, the debug mode may be stably controlled.

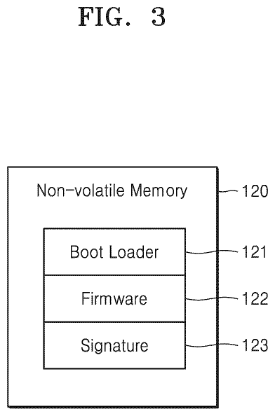

FIG. 3 is a block diagram of a memory area of a device, according to an embodiment.

Referring to FIGS. 2 and 3, in an embodiment, the non-volatile memory 120 may include a plurality of memory areas. In some embodiments, the non-volatile memory 120 may include a bootloader memory area 121, a firmware memory area 122, and a signature memory area 123. A program that boots the data storage device 100 may be stored in the bootloader memory area 121. The processor 110 may boot the data storage device 100 using the program in the bootloader memory area 121. In some embodiments, when power is applied to the data storage device 100, the processor 110 first executes a debug mode based on the debug circuit 111 and then accesses the bootloader memory area 121, thereby performing a booting operation.

An operating system (OS) and essential applications that operate the data storage device 100 may be stored in the firmware memory area 122. The firmware memory area 122 may include a plurality of areas that store multiple files of firmware, and the processor 110 may download the firmware by storing the received firmware FW in the firmware memory area 122. In some embodiments, after performing the debug mode and determining that the download has successfully completed, the processor 110 may execute the firmware by copying the firmware from the firmware memory area 122 to the RAM 130.

In some embodiments, signatures that indicate whether a plurality of download steps of the debug mode, hereinafter referred to as sub-steps, have been completed may be stored in the signature memory area 123. The plurality of sub-steps may include a series of operations that normally complete the download of firmware FW. For example, the plurality of download steps may include a start operation that indicates a start of download, and the processor 110 may store a start signature in the signature memory area 123 in response to the start operation. As will be described in detail below, the plurality of download steps may include various operations for downloading and normal execution of the firmware FW.

As described above, when each of the plurality of sub-steps is completed, the processor 110 may write a signature sig that corresponds to the completed sub-steps in the signature memory area 123. When all of the plurality of download steps for downloading the firmware FW are completed, the processor 110 may transmit a complete signature to the non-volatile memory 120, and the complete signature may be stored in the signature memory area 123. In some embodiments, when writing the start signature, if there is already a complete signature, the processor 110 may reinitialize the complete signature. For example, there may already be a complete signature because the previous firmware has been downloaded, and the processor 110 may reinitialize the existing complete signature to start a new debug mode for the newly received firmware FW.

In some embodiments, after performing a debug mode, the processor 110 may read a complete signature from the signature memory area 123, and boots the data storage device 100 when the complete signature is normally read. However, if the processor 110 fails to read the complete signature from the signature memory area 123, for example, if there is no complete signature, the processor 110 may execute the debug mode again without performing a boot operation. For example, a failure to read the complete signature indicates that the download of the firmware FW was not completed normally, and thus the processor 110 may perform a plurality of download steps of the firmware FW again by executing the debug mode again. In addition, in some embodiments, the processor 110 may repeatedly execute the debug mode as described above, and if it fails to read a completed signature from the signature memory area 123 even after repeated execution, the processor 110 may identify a step where an error has occurred by determining steps without a signature from the plurality of download steps. For example, the storage device 100 according to an embodiment may segment the plurality of download steps in a debug mode to control the steps, and an operation that corrects the errors can be performed based on a signature write operation that corresponds to the plurality of steps.

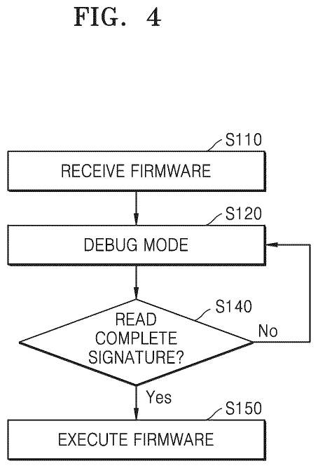

FIG. 4 is a flowchart of a firmware download method according to an embodiment.

Referring to FIG. 4, a firmware download method according to an embodiment may include a plurality of operations S110, S120, S140, and S150. Hereinafter, FIG. 4 will be described with reference to the previous drawings, and repeated descriptions of the previous drawings may be summarized or omitted.

In operation S110, the processor 110 may receive firmware FW to be downloaded from an external source. Reception of the firmware FW may be performed through an interface of the data storage device 100.

In operation S120, the processor 110 may execute a debug mode to download the firmware FW. The debug mode may be performed by the debug circuit 111 within the processor 110. In some embodiments, when power is applied to the data storage device 100, the processor 110 may first execute the debug mode before booting the system. The debug mode may include multiple download steps as described above. For example, the plurality of download steps may include a start operation to start downloading the firmware FW and an operation of writing the firmware FW to the firmware memory area 122 of the non-volatile memory 120. When all of the plurality of download steps are completed, the processor 110 may transmit and store a completed signature in the signature memory area 123.

In operation S140, the processor 110 may read the completed signature from the signature memory area 123. If the complete signature is normally read (YES in operation S140), the processor 110 may boot the data storage device 100. However, if reading of the complete signature has failed, the processor 110 may execute the debug mode of operation S120 again, without booting the data storage device 100. For example, if an error occurred during the download process of the firmware FW, the processor 110 may restore the firmware FW through a debug mode without executing the firmware FW, thereby preventing interruption of the operation of the device.

In operation S150, if the processor 110 succeeds in reading the complete signature (YES in operation S140), the processor 110 may boot the system and executes the downloaded firmware FW. The processor 110 may execute the firmware FW by copying the firmware FW from the firmware memory area 122 to the RAM 130.

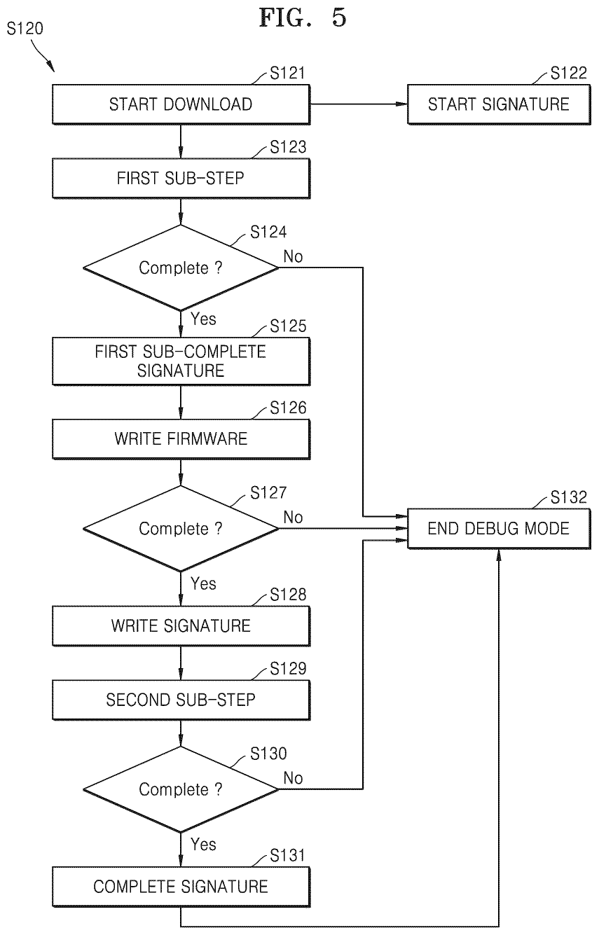

FIG. 5 is a flowchart of a debug mode according to an embodiment.

Referring to FIG. 5, operation S120 of performing the debug mode according to an embodiment may includes a plurality of operations S121 to S132. The plurality of debug mode download steps may include at least one sub-step. Hereinafter, FIG. 5 will be described with reference to the previous drawings, and repeated descriptions with reference to the previous drawings may be summarized or omitted.

In operation S121, the processor 110 may perform a start operation to initiate a download of the received firmware FW. In operation S122, the processor 110 may store a start signature in the signature memory area 123 in response to the start operation. In some embodiments, if there is already a complete signature, the processor 110 may reinitialize the existing complete signature to start a new debug mode.

In operation S123, the processor 110 may perform a first sub-step. For example, the first sub-step may be an operation of transmitting the received firmware FW to the non-volatile memory 120. In operation S124, the processor 110 may check whether the first sub-step has completed normally. If the first sub-step is normally completed (YES in S124), the processor 110 may write a first sub-complete signature that corresponds to the first sub-step to the signature memory area 123 (operation S125). If the first sub-step has not completed normally (NO in S124), the processor 110 may terminate debug mode (operation S132). For example, since an error has occurred in the first sub-step, the processor 110 may end the debug mode without performing subsequent sub-steps. The above-described first sub-step is an embodiment, and embodiments of the inventive concept are not necessarily limited thereto. In other embodiments, the first sub-step may refer to various other operations for downloading the firmware FW in addition to the operation of transmitting the firmware FW.

After the first sub-step has completed, in operation S126, the processor 110 may write (store) the firmware FW in the firmware memory area 122 of the non-volatile memory 120. In operation S127, the processor 110 may check whether writing the firmware FW has been completed normally. If the write operation has completed normally (YES in S127), the processor 110 may write a write signature to the signature memory area 123 (operation S128). If writing has not completed normally (NO in S127), the processor 110 may end the debug mode (operation S132).

After the write operation has completed, in operation S129, the processor 110 may perform a second sub-step. For example, the second sub-step may allow proper execution of the stored firmware FW. In some embodiments, the second sub-step may initialize elements within the data storage device 100. In an embodiment, the second sub-step may initializes a Power Management Integrated Circuit (PMIC), or initialize a DRAM. In an embodiment, the second sub-step may check a Transmission Line Pulse (TLP) circuit, or check a communication status between elements in the data storage device 100. For example, the second sub-step may refer to various operations that smoothly execute the firmware FW. In some embodiments, the second sub-step may be a final step for downloading the firmware FW, and if the second sub-step has completed normally (YES in S130), the processor 110 may write a complete signature to the signature memory area 123 (operation S131), and ends the debug mode (operation S132). However, if the second sub-step has not completed normally (NO in S130), the processor 110 may end the debug mode without a complete signature (operation S132).

For example, the processor 110 may write a complete signature when all of the plurality of download steps in the debug mode for downloading the firmware FW are completed, and then reads the complete signature in operation S140 to confirm that downloading of the firmware FW has completed normally.

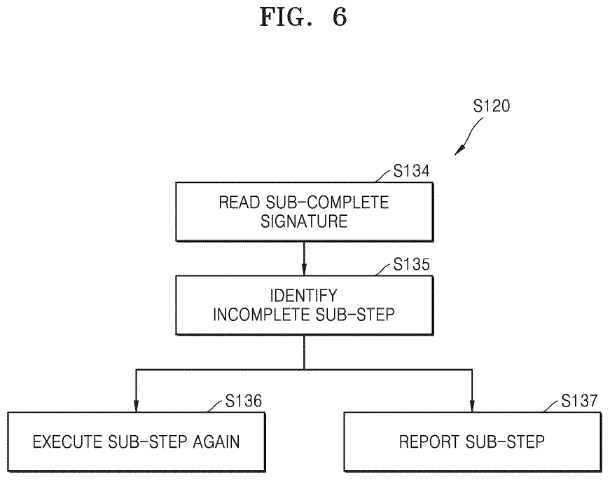

FIG. 6 is a flowchart of a debug method according to an embodiment.

Referring to FIG. 6, in a debug mode according to an embodiment, the processor 110 may identify a sub-step in which an error occurred. Hereinafter, FIG. 6 will be described with reference to the previous drawings, and repeated descriptions of the previous drawings may be summarized or omitted.

As described above, in an embodiment, the processor 110 may repeatedly execute the debug mode when the reading of the complete signature has failed. For example, if the download of firmware FW has not completed normally, a plurality of download steps in a debug mode may be repeatedly executed. In an embodiment, during a communication process of receiving the firmware FW, the downloading of the firmware FW might not be completed normally due to noise during transmission. For example, the processor 110 may normally complete the download of the firmware FW by repeatedly executing the debug mode.

In an embodiment, the downloading of the firmware FW might not be completed normally due to problems with the device that receives and stores the firmware FW. For example, the downloading of the firmware FW might not be completed normally due to an error in the memory, such as an SRAM and/or a DRAM, of the controller 30 that temporarily stores the firmware FW. For example, even if the processor 110 repeatedly executes the debug mode, the download might not be completed normally.

In some embodiments, when the processor 110 continuously fails to read a complete signature despite repeated execution of the debug mode as described above, the processor 110 may identify a sub-step where the problem occurs. In operation S134, the processor 110 may read a sub-complete signature that corresponds to each sub-step of the debug mode. As described above, when each sub-step is completed, the processor 110 may store a corresponding sub-complete signature in the signature memory area 123, and thus the processor 110 can read the stored sub-complete signature. In operation S135, when the processor 110 fails to read the sub-complete signature, the processor 110 may identify a sub-step, such as an incomplete sub-step, that corresponds to the sub-complete signature. For example, if a certain sub-step has not completed, as the processor 110 ends the debug mode without writing a sub-complete signature, there might not be a sub-complete signature that corresponds to the sub-step. Accordingly, the processor 110 may identify the sub-step that corresponds to the sub-complete signature that failed to read, as a step in which the problem occurred.

In some embodiments, in operation S136, the processor 110 may execute again the sub-step identified through operation S135, such as the sub-step in which the problem occurred. In an embodiment, the processor 110 may perform sub-steps to test whether communication between elements in the device is smoothly performed. For example, the sub-step might not be normally completed due to one of many phenomena, such as a problem with a certain device or a clock signal for a test operation, etc. For example, the processor 110 might not immediately end the debug mode but may execute the sub-step again. In an embodiment, the processor 110 may retest the communication status between the elements. If the sub-step is completed normally as a result of re-execution, the processor 110 may write a sub-complete signature that corresponds to the sub-step. The number of re-executions of sub-steps that were not normally completed can be implemented in various ways and may be set according to external control. For example, the processor 110 may perform a timer initialization sub-step and a general-purpose input output (GPIO) initialization sub-step, and when each step is completed normally, the processor 110 may write a sub-complete signature that corresponds to each sub-step. Afterwards, the processor 110 may perform an inter-integrated circuit (I2C) test operation. For example, the I2C test operation might not be completed normally due to an error in some of the devices on which a test is performed, and, for example, instead of immediately ending the debug mode, the processor 110 may perform the I2C test operation again. As a result of re-execution, if communication between the elements is smoothly performed and the test is completed, the processor 110 may write a sub-complete signature that corresponds to the I2C test operation to the signature memory area 123, and the download of the firmware may continue without interruption.

In some embodiments, in operation S137, the processor 110 may report the sub-step identified through operation S135, such as the sub-step in which a problem occurred. In an embodiment, the processor 110 may report that the sub-step has not completed due to the problem. For example, in a sub-step that tests whether communication between the elements is smoothly performed, the sub-step might not normally complete due to an error in a certain device or a timing problem. For example, the processor 110 may report problems that have occurred, such as an error in a device or a clock signal. In an embodiment, the processor 110 may report the status of the sub-step. In an embodiment, the processor 110 receive a certain command, such as a report command, and, in response, may report a completion status or progress status of the sub-step. For example, in response to a report command, the processor 110 may report on the completion status of the sub-step by accessing the signature memory area 123 and reading sub-complete signatures.

Accordingly, in a firmware download method according to an embodiment, an operation in which a problem has occurred can be quickly and accurately identified without additional work, and correction work that solves the problem may be easier.

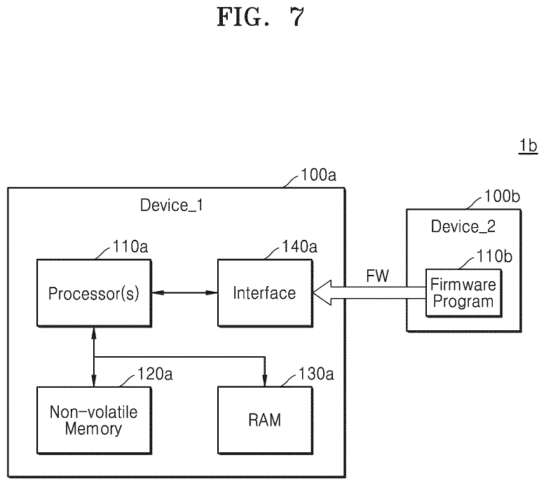

FIG. 7 is a block diagram of a firmware download system according to an embodiment.

Referring to FIG. 7, in an embodiment, a firmware download system 1b may include a first device 100a and a second device 100b. Hereinafter, FIG. 7 will be described with reference to the previous drawings, and repeated descriptions with reference to the previous drawings may be summarized or omitted.

The first device 100a may include at least one processor 110a, a non-volatile memory 120a, a RAM 130a, and an interface 140a. The at least one processor 110a may correspond to the processor 110 of FIG. 2, the non-volatile memory 120a may correspond to the non-volatile memory 120 of FIG. 2, and the RAM 130a may correspond to the RAM 130 of FIG. 2. The second device 100b may include a device that provides a firmware program 110b to the first device 100a, and the first device 100a may receive the firmware FW through the interface 140a.

The at least one processor 110a may execute a debug mode that downloads the firmware FW, and may store a sub-complete signature that corresponds to the non-volatile memory 120a in response to completing a plurality of download steps of the debug mode, such as each sub-step of the debug mode. The at least one processor 110a may store a complete signature when all sub-steps have completed. When the at least one processor 110a determines that the firmware FW has not downloaded properly, based on the complete signature, the processor 110a may execute the debug mode again. In addition, when the at least one processor 110a fails to read the complete signature, the at least one processor 110a may identify an incomplete sub-step by reading each sub-complete signature from the non-volatile memory 120a. In some embodiments, the at least one processor 110a may execute again a sub-step that did not complete normally. Additionally, in some embodiments, the at least one processor 110a may report whether an error has occurred in a sub-step that did not complete normally, or, upon receiving a report command, the processor 110a may report on the completion status of the sub-steps. When the download of the firmware FW has successfully completed, the at least one processor 110a may execute the firmware FW stored in the non-volatile memory 120a by copying the firmware to the RAM 130a.

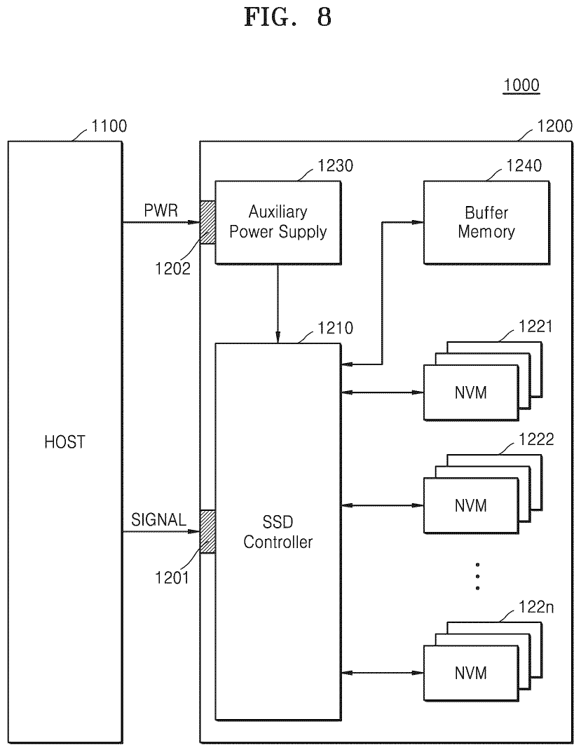

FIG. 8 is a block diagram of a data storage device incorporated into a solid state drive (SSD) system, according to an embodiment.

Referring to FIG. 8, an SSD system 1000 may include a host 1100 and an SSD 1200. The SSD 1200 may transmit and receive a signal SIGNAL to or from the host 1100 through a signal connector 1201 and receives power PWR through a power connector 1202. In an embodiment, the signal SIGNAL may provide firmware stored in the SSD 1200 through an SSD controller 1210.

The SSD 1200 may include the SSD controller 1210, non-volatile memory devices 1221 to 122n, an auxiliary power supply 1230, and a buffer memory 1240. The auxiliary power supply device 1230 may receive power PWR from the host 1100 that drives the SSD 1200. The buffer memory 1240 is not limited to a present embodiment and in other embodiments may be implemented inside the SSD controller 1210. In some embodiments, the buffer memory 1240 may be implemented inside and outside the SSD controller 1210. For example, the buffer memory 1240 may correspond to the volatile memory 33 in FIG. 1. The non-volatile memory devices 1221 to 122n may correspond to the NVM 40 of FIG. 1 and may include a NAND flash memory. For example, the SSD 1200 may be implemented using embodiments described above with reference to FIGS. 1 to 7. For example, the SSD controller 1210 in the SSD 1200 can download or update firmware according to the above-described embodiments. In an embodiment, the SSD controller 1210 may download firmware from the host 1100 based on a debug mode, and may prevent interruption of an operation of the SSD 1200 or data distortion due to an error during downloading.

While embodiments of the inventive concept have been particularly shown and described with reference to drawings thereof, it will be understood that various changes in form and details may be made therein without departing from the spirit and scope of the following claims.

What is claimed is:

1. An operating method of a storage device, the operating method comprising:
receiving firmware from an external host device;
executing a debug mode;
checking whether download steps of the firmware have completed by reading a complete signature; and
executing the firmware based on the complete signature,
wherein executing the debug mode comprises:
writing a start signature in response to a start operation of the download steps;
writing a write signature in response to completion of the write operation of the firmware of the download steps; and
writing the complete signature in response to all of the download steps having completed.

2. The operating method of claim 1, wherein the checking of whether the download steps are completed comprises repeating the executing of the debug mode in response to a failure to read the complete signature.

3. The operating method of claim 1, wherein the download steps further comprise at least one sub-step.

4. The operating method of claim 3, wherein the at least one sub-step comprises initializing peripheral devices.

5. The operating method of claim 3, wherein the executing of the debug mode comprises writing a sub-complete signature that corresponds to each of the at least one sub-steps in response to completion of each of the at least one sub-step.

6. The operating method of claim 5, wherein:
the checking of whether the download steps have completed comprises executing the debug mode in response to a failure to read the complete signature, and
the executing of the debug mode comprises identifying a sub-step that corresponds to a step of the failure to read the sub-complete signature.

7. The operating method of claim 6, wherein the identifying of the sub-step comprises executing the identified sub-step again.

8. The operating method of claim 6, wherein the identifying of the sub-step comprises reporting error details of the identified sub-step.

9. The operating method of claim 1, wherein the writing of a start signature comprises reinitializing the complete signature when the complete signature exists.

10. A data storage device, comprising:
at least one processor configured to control downloading of firmware by executing a debug mode in response to an application of power;
a nonvolatile memory that includes a bootloader memory area configured to store a program that boots the data storage device, a firmware memory area configured to store the firmware, and a signature memory area configured to store a signature that corresponds to each download step of the firmware; and
a random access memory (RAM) configured to copy, by the at least one processor, the firmware stored in the firmware memory area based on a complete signature,
wherein, in the debug mode, the at least one processor is configured to write a start signature in the signature memory area in response to a start operation of the download steps, write a write signature in response to completion of the write operation of the firmware of the download steps, and write the complete signature in response to completion of all of the download steps.

11. The data storage device of claim 10, wherein the at least one processor includes a debug circuit configured to execute the debug mode.

12. The data storage device of claim 10, wherein the at least one processor is further configured to execute the debug mode in response to a failure to read the complete signature.

13. The data storage device of claim 10, wherein the download steps further comprise at least one sub-step, and
in the debug mode, the at least one processor writes a sub-complete signature that corresponds to each of the at least one sub-steps in response to completion of each of the at least one sub-steps.

14. The data storage device of claim 13, wherein the at least one processor is further configured to execute the debug mode in response to a failure to read the complete signature, and
in the debug mode, the at least one processor is further configured to identify a sub-step that corresponds to a step of the failure to read the sub-complete signature.

15. The data storage device of claim 14, wherein the at least one processor is further configured to executes the identified sub-step again, and reports error details of the identified sub-step.

16. The data storage device of claim 10, wherein the at least one processor is further configured to reinitializes the complete signature when the complete signature exists, before writing the start signature.

17. A system, comprising:
a host device that provides firmware; and
a data storage device that includes at least one processor and configured to download the firmware from the host device and store the firmware in firmware memory area,
wherein the at least one processor is further configured to enter a debug mode to perform download steps of the firmware, boot the data storage device based on a program stored in a bootloader memory area, and copy firmware stored in the firmware memory area to a random access memory (RAM) and execute the firmware based on a complete signature of a signature memory area, and
in the debug mode, the at least one processor is further configured to write a start signature in the signature memory area in response to a start operation of the download steps, write a write signature in response to completing the write operation of the firmware of the download steps, and write the complete signature in response to completion of all of the download steps.

18. The system of claim 17, wherein the at least one processor is further configured to enter the debug mode in response to a failure to read the complete signature.

19. The system of claim 17, wherein the download steps further comprise at least one sub-step, and
in the debug mode, the at least one processor is further configured to write a sub-complete signature that corresponds to each of the at least one sub-step in response to completion of each of the at least one sub-step.

20. The system of claim 19, wherein the at least one processor is further configured to execute the debug mode in response to a failure to read the complete signature, and
in the debug mode, the at least one processor is further configured to identify a sub-step that corresponds to a step of the failure to read the sub-complete signature.
